(19) United States
(12) Patent Application Publication
(10) Pub. No.: US 2009/0126241 A1
(43) Pub. Date: May 21, 2009

(54) Electric fireplace insert and methods of use

(75) Inventor: Mark Asofsky, Delray Beach, FL (US)

Correspondence Address: RUDEN, MCCLOSKY, SMITH, SCHUSTER & RUSSELL, P.A., 222 LAKEVIEW AVE, SUITE 800, WEST PALM BEACH, FL, 33401-6112, US

(73) Assignee: Twin-Star International, Inc.

(21) Appl. No.: 12/274,541

(22) Filed: Nov. 20, 2008

Related U.S. Application Data
(60) Provisional application No. 60/989,281, filed on Nov. 20, 2007.

(51) Int. Cl. G09F 19/00; H04N 9/31

(52) U.S. Cl. 40/428; 348/744

(57) ABSTRACT

An electric fireplace insert and methods for simulating the light and sound effects of real burning fuel utilize one or more of a light emitting diode (LED) down lighting system, an LED flame light system, and an LED ember bed light system which work together to make the electric fireplace insert more closely resemble the appearance and sounds of a traditional fuel-burning fireplace. By simultaneously and independently changing the brightness of several groups of LEDs of the LED down lighting system, a shadow motion effect of ambient light similar to that seen in a traditional fuel-burning fireplace can be simulated. By simultaneously and independently changing the brightness of several groups of LEDs of the LED ember bed lighting system, a rolling motion, or side-to-side, effect of light inside the ember bed can be simulated. The flashing of the LEDs of the LED ember bed lighting system and/or the LED simulated fuel lighting system can also be synchronized by the CPU with crackling sounds that may be stored on a memory chip and emitted by the audio speaker to simulate the sparks and associated crackling noise of burning fuel. The electric fireplace insert can be included in a fireplace housing having a front portion to which can be attached one of a set of different-looking, removable, decorative face plates.

### CROSS-REFERENCE TO RELATED APPLICATION

This application claims the priority of U.S. provisional patent application Ser. No. 60/989,281 filed on Nov. 20, 2007.

### FIELD OF THE INVENTION

The invention relates to electric fireplaces and components thereof. More particularly, the invention relates to electric fireplace inserts having lighting and sound systems that closely simulate the flame appearance and sound of a traditional wood- or coal-burning fireplace.

### BACKGROUND

As a source of heat and for aesthetic reasons, fireplaces are frequently incorporated into homes. There are currently several fireplace options available to consumers: traditional fuel (wood or coal)-burning fireplaces, gas-burning fireplaces, and electric fireplaces. Traditional fuel-burning fireplaces generally offer the greatest heat-production and aesthetics, but require more set-up and maintenance time to operate. Gas-burning fireplaces offer a real flame and convenience, but lack the natural sound, flickering, and shadowing associated with traditional fuel-burning fires. Electric fireplaces do not offer a real flame, but have many safety and convenience features.

### SUMMARY

An improved electric fireplace featuring a number of innovative components has been developed. These innovations work together to make an electric fireplace more closely resemble the appearance and sounds of a traditional fuel-burning fireplace. In particular, an electric fireplace of the invention can feature one or more of the following innovative systems: a light emitting diode (LED) down light system, a LED flame light system, a LED ember bed light system, a LED simulated fuel light system, a controller having a central processing unit (CPU), and interchangeable face plates for the fireplace housing.

The LED flame light system may include several LEDs located in different positions within a fireplace insert. Each LED light of the LED flame light system can be independently connected to and, therefore, independently controlled by the CPU. In one embodiment, a reflecting spindle within the fireplace insert rotates and light from the LEDs of the LED flame light system is projected onto the reflectors located on the spindle. The reflectors then reflect the light at different angles through a flame cutout panel onto a projection screen to simulate the flames of a fuel-burning fireplace.

The LED down lighting system may include one or more LEDs or groups of LEDs installed on the top inside wall of an insert within the fireplace insert. By simultaneously and independently changing the brightness of several groups of LEDs of the LED down lighting system, a shadow motion effect of ambient light similar to that seen in a traditional fuel-burning fireplace can be simulated.

The fireplace insert can also include a simulated ember bed beneath which an LED ember bed lighting system, which includes several groups of independently controlled LEDs, is installed. As above, by simultaneously and independently changing the brightness of several groups of LEDs of the LED ember bed lighting system, a rolling motion, or side-to-side, effect of light inside the ember bed of a fuel-burning fireplace can be simulated. The flashing of the LEDs of the LED ember bed light system can also be synchronized by the CPU with crackling sounds that may be stored on a memory chip and emitted by the audio speaker to simulate the sparks and associated crackling noise of burning embers.

The fireplace insert can also include a simulated fuel source having integrated therein an LED simulated fuel source lighting system, which can include several groups of independently controlled LEDs. By simultaneously and independently changing the brightness of several groups of LEDs of the LED simulated fuel source lighting system, the look of burning a traditional fuel source in an actual fireplace can be simulated. As above, the flashing of the LEDs of the LED simulated fuel source lighting system can also be synchronized by the CPU with crackling sounds that may be stored on a memory chip and emitted by the audio speaker to simulate the sparks and associated crackling noise of burning fuel.

The controller, which includes the CPU, can be used to control the light variations of the LEDs including the shadow motion effect of the LED down lighting system, the ember bed lighting system effects, the simulated fuel source lighting system effects, and the flame light system effects. The controller can also control the play of simulated burning fuel sounds and wind noises of flames being sucked up a chimney, and can be used to adjust the volume of the sounds.

The fireplace housing may include interchangeable face plates that fit over the outer portion of the housing so that the external appearance of the fireplace housing may be changed as desired by the user. The face plates form a decorative trim, e.g., chrome, brass, antique finish, etc., that can be interchangeably connected to the fireplace housing's outer portion.

Accordingly, in one aspect, the invention features an electric fireplace insert including a projection screen onto which light can be projected to simulate the appearance of flames; a flame light system including a plurality of flame light-emitting diodes arranged to produce light that is projected onto the projection screen in the form of simulated flames; a simulated fuel source having an outer surface including at least one translucent or transparent portion, and at least one interior cavity defined at least in part by the at least one translucent or transparent portion; a simulated fuel source lighting system including a plurality of simulated fuel source light-emitting diodes arranged to project light into the at least one interior cavity of the simulated fuel source and onto the at least one translucent portion of the simulated fuel source; a simulated ember bed having an outer surface including at least one translucent or transparent portion, and at least one interior cavity defined at least in part by the at least one translucent or translucent portion; a simulated ember bed lighting system including a plurality of ember bed light-emitting diodes arranged to project light into the at least one interior cavity of the simulated ember bed and onto the at least one translucent portion of the simulated ember bed; and a controller including at least one central processing unit, and controlling the operation of flame light system, the simulated fuel source lighting system, and the simulated ember bed lighting system.

In the electric fireplace, the plurality of flame light-emitting diodes can include at least a first flame light-emitting diode and a second flame light-emitting diode, the first flame light-emitting diode being controlled by the controller independently from the second flame light-emitting diode. Similarly, the plurality of fuel source light-emitting diodes can include at least a first fuel source light-emitting diode and a second fuel source light-emitting diode, the first fuel source light-emitting diode being controlled by the controller independently from the second fuel source light-emitting diode; and the plurality of ember bed light-emitting diodes can include at least a first ember bed light-emitting diode and a second ember bed light-emitting diode, the first ember bed light-emitting diode being controlled by the controller independently from the second ember bed light-emitting diode.

In certain variations of the electric fireplace insert, the plurality of fuel source light-emitting diodes can include at least a first fuel source light-emitting diode and a second fuel source light-emitting diode, the first fuel source light-emitting diode being controlled by the controller independently from the second fuel source light-emitting diode; and/or the plurality of ember bed light-emitting diodes can include at least a first ember bed light-emitting diode and a second ember bed light-emitting diode, the first ember bed light-emitting diode being controlled by the controller independently from the second ember bed light-emitting diode.

In another aspect, the electric fireplace insert includes a right interior facade positioned on a right interior side wall of the insert, a left interior facade positioned on a left interior side wall of the insert, and a down lighting system including a plurality of down light light-emitting diodes arranged to project light onto the simulated fuel source, the right interior facade, and the left interior facade. The plurality of down light light-emitting diodes can include at least a first down light light-emitting diode, a second down light light-emitting diode, and a third down light light-emitting diode, wherein the first down light light-emitting diode light-emitting diode is controlled by the controller independently from the second down light light-emitting diode and the third down light light-emitting diode.

The electric fireplace can further include a memory storage device having stored therein a file encoding a soundtrack, and an audio speaker in communication with the storage device. The soundtrack can include a pattern of sounds that simulates the sound of burning wood, and the pattern of sounds can be arranged not to repeat for at least 30 seconds. The controller can synchronize the pattern of sounds with the flashing of at least one of the light-emitting diodes including the flame light system, the simulated fuel source lighting system, or the simulated ember bed lighting system.

In another aspect, the invention features a method including the steps of simultaneously: using a first set of light-emitting diodes to project simulated flames onto a projection screen positioned in an electric fireplace insert; and using a second set of light-emitting diodes to project light into an interior cavity of a simulated fuel source positioned in the electric fireplace insert and having an outer surface including at least one translucent or transparent portion that defines at least in part the at least one translucent or transparent portion. This method might further include the step of: using a third set of light-emitting diodes to project light into an interior cavity of a simulated ember bed positioned in the electric fireplace insert and having an outer surface including at least one translucent or transparent portion that defines at least in part the at least one translucent or transparent portion; and/or using a third set of light-emitting diodes to project light downward onto the simulated fuel source, a right interior facade of the fireplace insert, and a left interior facade of the fireplace insert.

The method might also include the step of: playing a soundtrack through an audio speaker position on the fireplace insert, wherein the soundtrack can include a pattern of sounds that simulates the sound of burning wood and/or does not repeat for at least 30 seconds. The pattern of sounds can be synchronized with the flashing of at least one of the light-emitting diodes.

Unless otherwise defined, all technical terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents and other references mentioned herein are incorporated by reference in their entirety. In the case of conflict, the present specification, including definitions will control.

### BRIEF DESCRIPTION OF THE DRAWINGS

FIG. 1 is a perspective view of the front of an electric fireplace of the invention.

FIG. 2 is a cutaway perspective view of the front of the electric fireplace of FIG. 1.

FIG. 3 is a side mid-sectional view of the electric fireplace of FIG. 1.

FIG. 4A is a perspective view of the front of a logset and grate of the electric fireplace of FIG. 1.

FIG. 4B is a perspective view of the back of the logset and grate of the electric fireplace of FIG. 4A.

FIG. 5 is a perspective view of the back of the electric fireplace of FIG. 1 with the back cover removed.

FIG. 6 is a chart showing the synchronized wave functions of a crackling, burning sound signal and an LED sparking activation signal.

FIG. 7 is a perspective view of the front of an electric fireplace showing the interchangeable face plates.

FIG. 8 is a series of charts showing control of various LEDs in the lighting systems of an electric fireplace insert.

### DETAILED DESCRIPTION

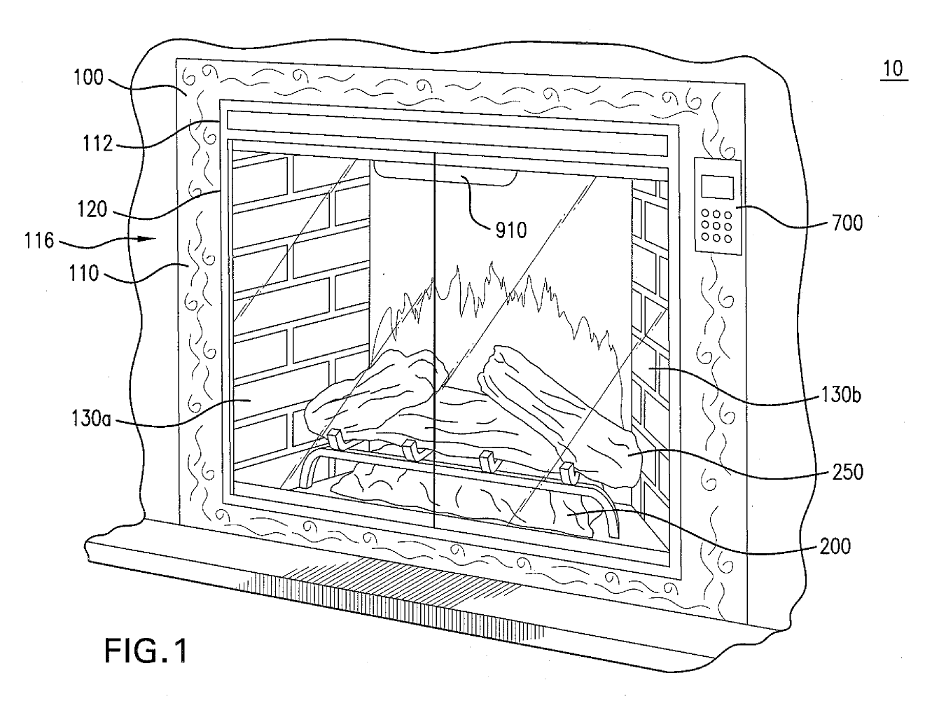

Referring now to FIGS. 1-7, in one aspect, the invention provides an electric fireplace 10 that may include a fireplace housing 100, and a fireplace insert 120 that can include a simulated ember bed 200, a simulated fuel source 250 (e.g., a simulated log set, or faux coal and stone fuel beds), an audio speaker 300, and a hot air generator 400. In addition to these components, the electric fireplace insert 120 may include a projection screen 500 and a rotating spindle 600 having one or more reflectors 610; an electric fireplace controller 700 having a central processing unit 710 (CPU); and at least one of the following flame light simulation systems: a LED down lighting system 910; a LED flame light system 920; a LED ember bed light system 930; and a LED simulated fuel source lighting system 940. The insert 120 can be included in the housing 100 which can include an interchangeable face plate system 800 including one or more interchangeable face plates 810a, 810b attachable over a front portion 110 of the fireplace housing 100.

The fireplace housing 100 may also include a fireplace surround (e.g., including a hearth, a mantle, or both), and can be manufactured from synthetic materials, such as plastics or metals, or from more natural materials, such as brick or wood. The electric fireplace 10 can include a fireplace insert 120 to which can be attached the light emitting diode (LED) down lighting system 910, the LED flame light system 920, the LED ember bed lighting system 930, the LED simulated fuel source lighting system 940, as well as two interior facades 130a, 130b adjoining each end of the insert 120, other functional electrical fireplace components, and a chassis incorporating such parts.

The fireplace housing may further include the interchangeable face plates 800 that fit over the outer face of front portion 110 of the housing 100 so that the external appearance of the fireplace housing may be changed as desired by the user. The front portion 110 of the fireplace housing 100 can include only a facing 112 of the electric fireplace 10, only a fire surround of the electric fireplace, or both the facing 112 and the fire surround. The face plates 800 may be shaped and designed to connect to and cover only the facing 112, only the fire surround 114, or both the facing 112 and fire surround. The face plates 800 form a decorative trim, e.g., chrome, brass, antique, patterned finish, etc., that can be interchangeably connected to the outer portion 116 of the fireplace housing 100.

The simulated ember bed 200 can be seated within the fireplace insert 120 and, in one embodiment, may include certain attachment points 210 for connecting the LED ember bed light system 930. In an exemplary embodiment, the ember bed 200 can be semi-translucent so as to render visible to a viewer the light produced by the LED ember bed light system 930. In another embodiment, the simulated ember bed 200 may include apertures or transparent areas 220 to permit viewing of light produced by the LED ember bed light system 930.

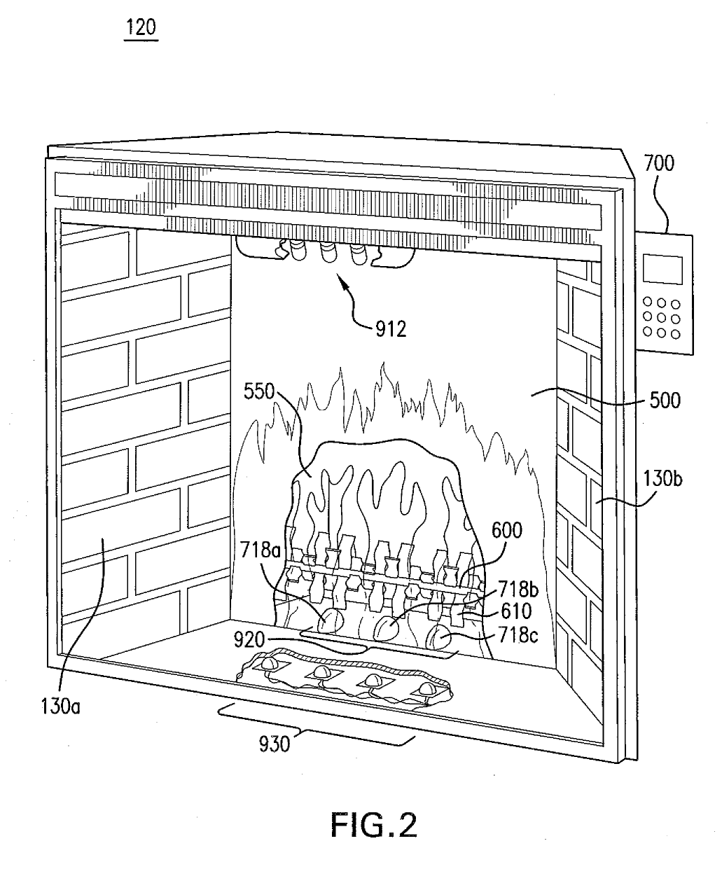

As illustrated in FIGS. 2, 3, and 5, the one or more reflectors 610 of the rotating spindle 600 may be shaped as finger-like projections. The rotating spindle 600 may be rotated by a mechanical device 620. The LED flame light system 920 may be composed of several flame light LEDs 922 located in different positions within the fireplace housing 100. Each flame light LED 922 of the LED flame light system 920 may be independently connected to and, therefore, independently controlled by the CPU 710. Each flame light LED 922 and/or set of flame light LEDs 922 (e.g., 2, 3, 4, 5, or 6 individual LEDs) of the LED flame light system 920 can be controlled by a different input/output (I/O) port 712 of the CPU 710, thereby permitting the brightness of each LED 922 and/or set of LEDs 922 to be independently controlled.

In one embodiment of the LED flame light system 920, several LEDs 922 can be mounted within a group of conical reflectors 718a, b, c. In an exemplary embodiment, the LED flame light system can include three flame light LEDs 922 installed within three conical reflectors 718. The angles between each of the three flame light LEDs 922 installed within three conical reflectors 718 in this embodiment may equal about 120 degrees (e.g., 110, 111, 112, 113, 114, 115, 116, 117, 118, 119, 120, 121, 122, 123, 124, 125, 126, 127, 128, 129, or 130°) to provide maximum light concentration. The conical reflector 718 can concentrate the light rays produced by the flame light LEDs 922 onto the projection screen 500. The LED flame light system 920 may include a plurality of groups of LEDs 922 mounted within a plurality of conical reflectors 718.

In another embodiment of the LED flame light system 920, several flame light LEDs 922 and/or sets of LEDs 922 can be mounted in a straight line to direct light toward the rotating spindle 600 and its reflectors 610. Other alternative geometric arrangements of the flame light LEDs 922 are also contemplated.

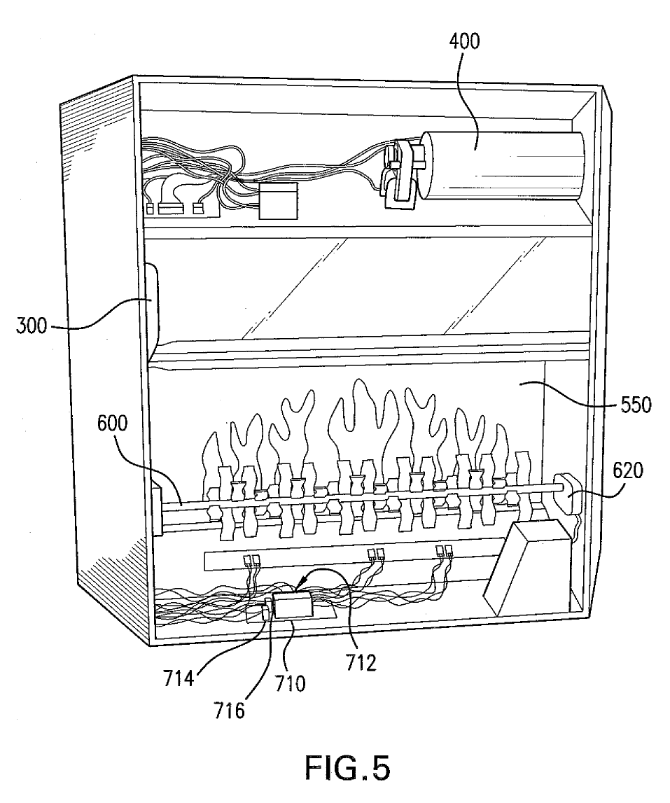

As the spindle 600 within the fireplace insert 120 rotates, light from the flame light LEDs 922 of the LED flame light system 920 can be projected onto the reflectors 610 located on the spindle 600. The reflectors 610 then reflect the light at different angles onto the projection screen 500 to simulate the flames of a fuel-burning fireplace. Although this can be performed directly, in some embodiments, a flame cutout panel 550 is interposed between the flame light LEDs 922 and the projection screen 500 as shown in FIGS. 2, 3, and 5. The flame cutout panel 550 can be made of a panel of light-blocking material having one or more portions therein cut out in the pattern of flames as shown in FIG. 5. The flame cutout panel 550 thus acts as a stencil that forms the light reflected of the spindle 600 into a flame-like shape before it hits the projection screen 500.

In one embodiment, the projection screen 500 may be manufactured from a transparent thermoplastic such as Plexiglas®. The thermoplastic can be about 2.5 millimeters (mm) or less, e.g., about 0.1, 0.2, 0.5, 0.9, 1.0, 1.25, 1.5, 1.75, 2.0, 2.4, 2.6, 2.9, 3.0, 4.0, or 5.0 mm, in thickness. In another embodiment, the projection screen 500 may be manufactured from a colored plastic film (e.g., white, yellow, orange, red, or crimson). The colored plastic film can be about 1.0 mm or less, e.g., about 0.01, 0.1, 0.2, 0.5, 0.75, 0.9, 1.1, 1.25, 1.5, 1.75, 2.0, 2.5, 3.0, or 4.0 mm, in thickness.

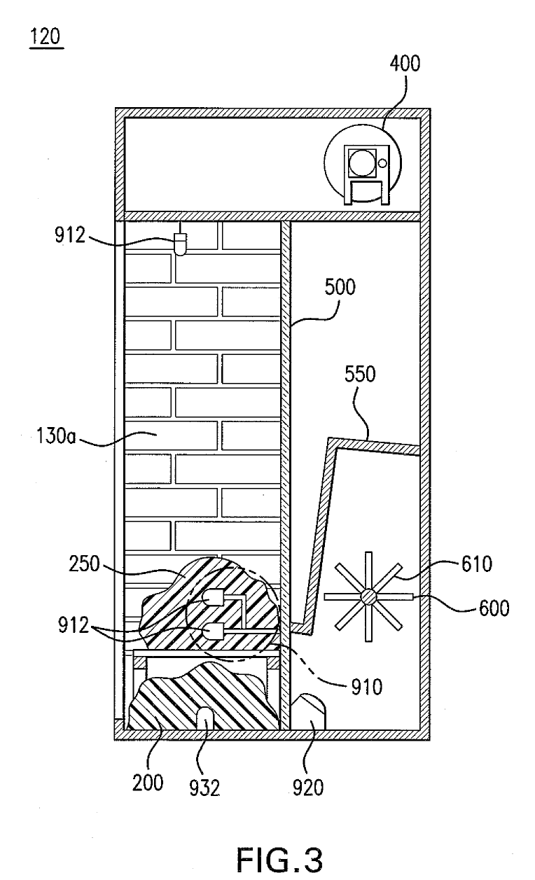

As shown in FIGS. 2 and 3, the LED down lighting system 910 may include one or more down light LEDs 912 or groups of down light LEDs 912 installed on the top inside wall of the insert 120. In one embodiment, the down light LEDs 912 of the LED down lighting system 910 are oriented in several different directions, including toward interior facades 130 located on either side of the insert and toward to the simulated fuel source 250. In an exemplary embodiment, the LED down lighting system 910 includes three down light LEDs 912, including one oriented toward the left interior facade 130a, one oriented toward the right interior facade 130b, and one oriented perpendicularly to the ember bed 200. Each down light LED 912 and/or set of down light LEDs 912 of the LED down lighting system 910 can be controlled by a different input/output (I/O) port 712 of the CPU 710, thereby permitting the brightness of each down light LED 912 and/or group of down light LEDs 912 to be independently controlled. By simultaneously and independently changing the brightness of several down light LEDs 912 and/or set of down light LEDs 912 of the LED down lighting system 910, a shadow motion effect of ambient light similar to that seen in an actual fireplace can be simulated within the fireplace housing.

Referring now to FIGS. 1-3, the LED ember bed lighting system 930 can be installed beneath the simulated ember bed 200 and may include several ember bed LEDS 932 and/or groups of ember bed LEDs 932 which are preferably independently-controlled. The simulated ember bed 200 can be fashioned from synthetic materials (e.g., plastic) and colored to resemble the appearance of a real ember bed. The simulated ember bed 200 includes a plurality of light transmitting portions (e.g., transparent or translucent regions) that allows light from the ember bed LEDs 932 to glow on the top surface of the ember bed 200 in a pattern similar to a real ember bed. Each ember bed LED 932 and/or group of ember bed LED 932 of the LED ember bed light system 930 can be controlled by a different input/output (I/O) port 712 of the CPU 710, thereby permitting the brightness of each ember bed LED 932 and/or group of ember bed LEDs 932 to be independently controlled. Individual ember bed LEDs 932 can be activated to simulate sparks and sets of ember bed LEDs 932 can be activated to simulate the effect of the movement of glowing light emitted by burning a traditional fuel source. By simultaneously and independently changing the brightness of several ember bed LEDs 932 and/or sets of ember bed LEDs 932 of the LED ember bed light system 930, a rolling motion, or side-to-side, effect of glowing light inside the ember bed of an actual fireplace can be simulated.

As illustrated in FIGS. 1-4, the LED simulated fuel source lighting system 940 can be installed on a grate 260 and seated within the insert 120. The combination of the grate 260 and simulated fuel source 250 can be detachable from the insert 120 for easy replacement. In an exemplary embodiment, the simulated fuel source 250 can be semi-translucent so as to render visible to a viewer the light produced by the LED simulated fuel source lighting system 940. In another embodiment, the simulated fuel source 250 may include apertures or transparent areas to permit viewing of light produced by the LED simulated fuel source lighting system 940.

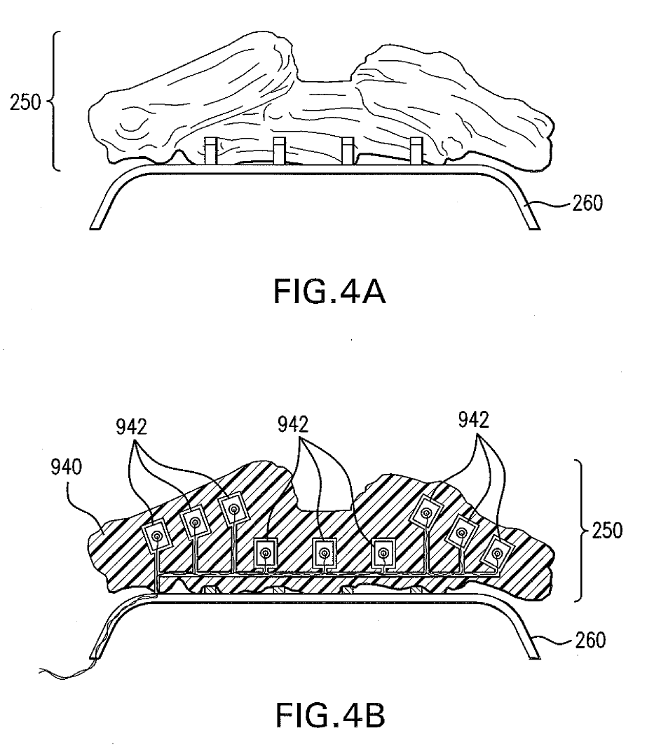

Several fuel source LEDS 942 and/or sets of fuel source LEDs 942 can be installed into the back face of the simulated fuel source 250 as shown in FIG. 4b. The simulated fuel source 250 can be made from synthetic materials (e.g., plastic) to resemble the appearance of a traditional fuel source (e.g., wood or coal) or a series of stones. The simulated fuel source 250 includes a plurality of light transmitting portions (e.g., transparent or translucent regions) that allows light from the fuel source LEDs 942 to illuminate the outer surface of the simulated fuel source 250 in a pattern similar to a traditional fuel source (e.g., with several different regions having different light intensity which may follow the cracks and crevices of the simulated fuel source 250).

Each fuel source LED 942 and/or set of fuel source LEDs 942 can be controlled by a different input/output (I/O) port 712 of the CPU 710, thereby permitting the brightness of each fuel source LED 942 and/or set of fuel source LEDs 942 to be independently controlled. Individual fuel source LEDs 942 can be activated to simulate sparks and sets of fuel source LEDs 942 can be activated to simulate the effect of the movement of glowing light emitted by a traditional burning log. By simultaneously and independently changing the brightness of several fuel source LEDs 942 and/or sets of fuel source LEDs 942 of the LED simulated fuel source lighting system 940, a rolling motion, or side-to-side, effect of glowing light inside a traditional fuel source can be simulated.

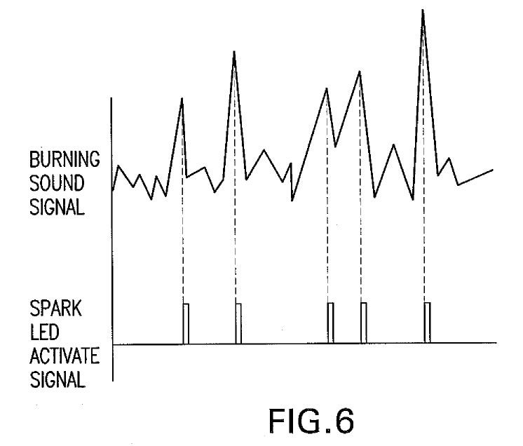

The flashing of the ember bed LEDs 932 and/or fuel source LEDs 942 can also be synchronized by the CPU 710 with crackling sounds that may be stored on a memory storage device 716 (e.g., a memory chip) and emitted by the audio speaker 300 to simulate the sparks and associated crackling noise of burning fuel or embers. The sound track stored on the memory storage device 716 preferably is at least about 30 seconds long (e.g., at least 25, 30, 45, 60, 75, 90, 105, or 120 seconds long) as it has been discovered that most people cannot perceive a repeating sound pattern when the length of the soundtrack is at least about 30 seconds long. Similarly, a program that controls LED activation of the LED down lighting system 910, the LED flame light system 920, the LED ember bed light system 930, and/or the LED simulated fuel source lighting system 940 preferably encodes a lighting pattern that is at least about 30 seconds long (e.g., at least 25, 30, 45, 60, 75, 90, 105, or 120 seconds long) so that most people do not perceive a repeating lighting pattern. In one embodiment, as shown in FIG. 6, when the crackling noise reaches certain predetermined peak volumes, one or more ember bed LEDs 932 and/or groups of ember bed LEDs 932 can be activated by the CPU 710 to emit light from beneath the ember bed 200 to simulate sparks of actual burning fuel.

The electric fireplace controller 700 (which can include one or more components physically attached to the fireplace housing 100 or an infrared or radio frequency remote control unit), which can include and/or be in signaling communication with the CPU 710, can be used to control the light variations of the various LEDs including the shadow motion effect of the LED down lighting system 910, the LED ember bed light system's 930 sparking light effects, the LED simulated fuel source lighting system's 940 effects, and the LED flame light system's 920 effects. The controller 700 can also control the audio speaker 300 to, e.g., turn on or off the sound, vary the volume or tone, and to play one or more different soundtracks (e.g., simulated burning fuel sounds and/or simulated wind noises of flames being sucked up a chimney).

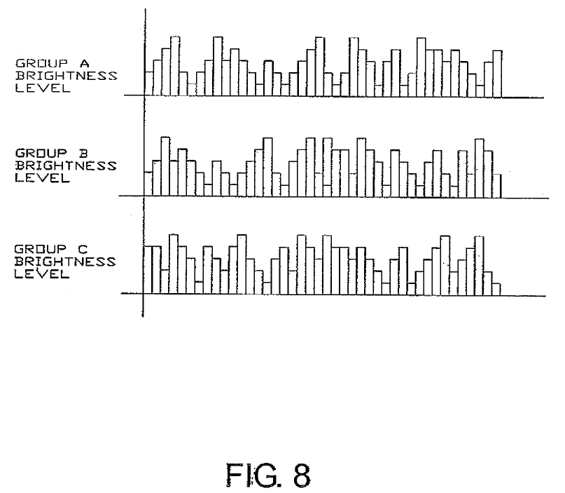

In one embodiment, the flame light system, the down lighting system, the ember bed lighting system, and/or the simulated fuel source lighting system can have three groups (left, right, and center) of LEDs that are each independently controlled by the controller. The LEDs can have five available brightness settings, and the CPU can be programmed to select brightness levels of each LED as illustrated in the charts shown in FIG. 8. As shown, the brightness control program is not random. Rather the brightness levels step up and down in a programmed sequence (e.g., at 40, 50, 60, 70, 80, 90, 100, 110, 120, 130, 140, 150, or 160±1, 2, 3, 4, or 5 millisecond intervals) to create a smooth changing effect. Testing showed that random changes in LED brightness levels caused the effects to blink rather than change smoothly.

Referring to FIG. 5, where the electric fireplace 10 includes a hot air generator 400, the CPU 710 of the controller 700 may also be used to adjust and control the temperature of the heated air that is generated as well as fan speed. The electric fireplace 10 might include a thermostat 410 for adjusting and controlling the temperature of the heated air. The hot air generator 400 can be an electric device or can be a gas-burning device. The electric fireplace 10 and its components can be powered by connection to any conventional power source (e.g., a household electrical source or battery) or by alternative power source, such as electricity produced from solar or wind energy.

The invention also provides methods for simulating the appearance and sounds of burning fuel in a traditional fireplace. Two or more of these methods can be activated simultaneously in an electric fireplace, or only one of the methods may be used within the electric fireplace.

In one method, referring to the FIGS. 1-6, the appearance of the flames of burning fuel is simulated by the fireplace insert 120. One or more flame light LEDs 922 and/or sets of flame light LEDs 922 of the LED flame light system 920 are activated by signals from the CPU 710 of the controller 700. Light emitted by these flame light LEDs 922 can be directed toward one or more of the reflectors 610 of the rotating spindle 600, which may be installed within the fireplace housing 100 of the electric fireplace 10. Light from the flame light LEDs 922 can be reflected by the reflectors 610 onto the projection screen 500, thereby producing a flame light effect to simulate the moving flames of actual burning fuel. In one step of this method, each flame light LED 922 or set of flame light LEDs 922 can be connected to a different I/O port 712 of the CPU 710 so that the brightness of each flame light LED 922 can be independently controlled by the CPU 712.

In another method, the appearance of glowing light created by an actual burning fuel source and/or ember bed is simulated by an electric fireplace insert. In a real burning fuel source and ember bed, this glowing light produced by the release of heat energy can appear to move, or roll, across an external surface of the fuel source and/or ember bed so that the brightness of the glowing light changes across the external surface of the fuel source and/or ember bed. In an exemplary embodiment of the method, one or more ember bed LEDs 932 or sets of ember bed LEDs 932 of the LED ember bed light system 930 mounted beneath a semi-translucent ember bed 200 are activated by the CPU 710 of the controller 700. The light emitted by the activated LEDs 932 beneath the ember bed 200 simulates the movement and pulsing of glowing light as the light changes in color and intensity across actual burning embers. In one step of this method, each ember bed LED 932 can be connected to a different I/O port 712 of the CPU 710 so that the brightness of the light emitted by each ember bed LED 932 can be independently controlled by the CPU 710. The LED simulated fuel source lighting system 940 can be controlled in the same fashion, independently or in conjunction with, the LED ember bed lighting system 930.

In another method, the appearance of sparks within actual burning fuel can be simulated in an electric fireplace insert. One or more individual ember bed LEDs 932 and/or simulated fuel source LEDs 942 can be activated by a CPU 710 of a controller 700 to produce an intense light that simulates the sparks that occur when traditional fuel is burned. In one step of this method, each ember bed LED 932 and/or each simulated fuel source LED 942 can be connected to a different I/O port 712 of the CPU 710 so that the brightness of the light emitted by each ember bed LED 932 and/or simulated fuel source LED 942 can be independently controlled by the CPU 710.

Referring to FIG. 6, the CPU 710 may control the timing and sequence of activation of these ember bed LEDs 932 and/or simulated fuel source LEDs 942 to coincide with peak waves connected with the production of crackling sounds that are also controlled by the CPU 710. In this embodiment, the CPU 710 detects each peak wave of crackling sound that exceeds a predetermined threshold of volume (e.g., 10, 15, 20, 25, 30 or more decibels above the mean decibel level of the soundtrack) and provides a simultaneous command for the activation of specific, independently-controlled ember bed LEDs 932 and/or simulated fuel source LEDs 942 for the simulation of sparks in burning fuel.

In another method, the appearance of moving shadows is created within the fireplace insert 120 of the electric fireplace 10 to simulate the moving shadows caused by the flickering flames of real burning fuel. In an exemplary embodiment of the method, about three or more (e.g., 3, 4, 5, 6, 7, 8, 9, 12, 15, 18, 21, or 24) down light LEDs 912 of the LED down lighting system 910 installed inside the fireplace insert 120 are activated by the CPU 710 of the controller 700. In one step of this method, each down light LED 912 can be connected to a different I/O port 712 of the CPU 710 so that the brightness of the light emitted by each down light LED 912 can be independently controlled by the CPU 710. By independently and simultaneously adjusting the brightness of several of the down light LEDs 912, the moving shadows of ambient light can be simulated within the fireplace housing.

In another method of the invention, a CPU 710 of a controller 700 can include a sound database saved within a data storage device 716 (e.g. a solid state memory chip). While the LEDs 912, 922, 932 of one or more of the LED down lighting system 910, the LED ember bed light system 930, the LED simulated fuel source lighting system 940, and the LED flame light system 920 are activated to simulate traditional fuel burning within the electric fireplace 10, the CPU 710 can command the playback of burning fuel sounds selected from the sound database and played through the audio speaker 300.

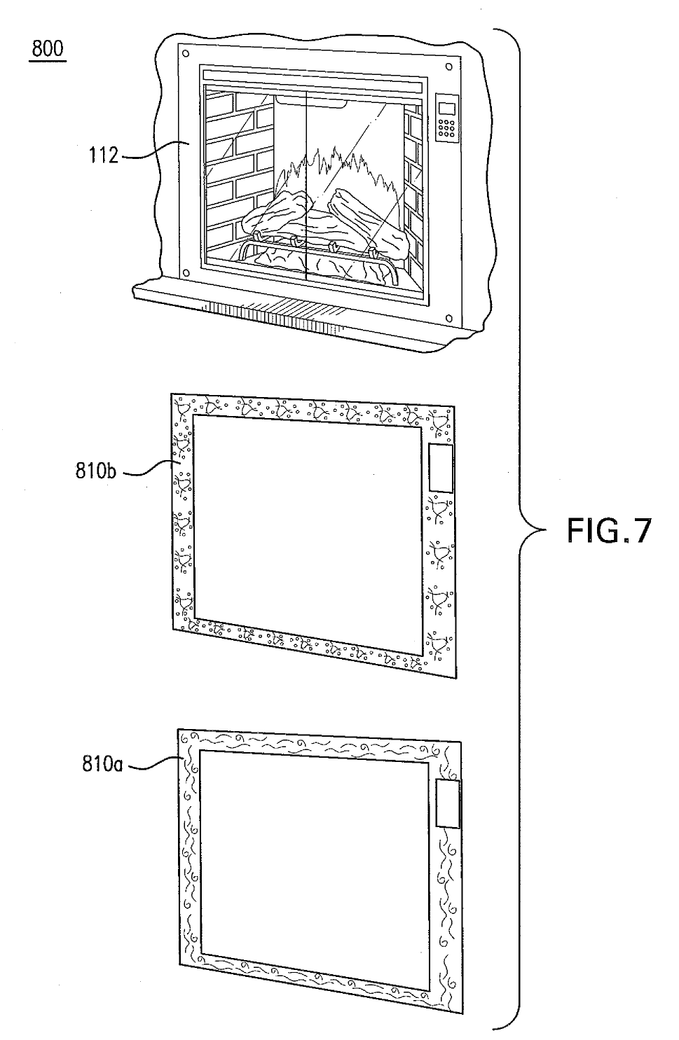

In still another method of the invention, referring to FIG. 7, the appearance of a front portion of a fireplace housing 100 of an electric fireplace can be altered by connecting, interchanging, and removing one or more face plates 810a, 810b from the front portion 110. The face plates can be decorative in nature and can be easily connected to and removed from the front portion of the fireplace housing using conventional fastening means, e.g., via attachment points 210.

While the embodiments described above feature a reflector-containing rotating spindle to reflect light from flame light LEDs onto a projection screen, in other embodiments within the invention, the appearance of a flame can also be simulated using a spindleless device. For example, to create the appearance of flames, a ribbon fire system might be used wherein ribbons are placed between the flame light source and the projection screen and air is blown onto the ribbons to make them move in a side-to-side manner such that the light transmitted through the ribbons mimic the look of real flames on the projection screen. As another example, flames can be simulated in an electric fireplace lacking a rotating spindle using CPU-controlled flame light LEDs positioned behind a flame cutout panel which is behind a projection screen. In one such embodiment, the flame light LEDs are arranged in strips or a panel positioned roughly parallel to the flame cutout panel. Rather than using the mechanical movement of a reflective spindle to create a flame motion effect, this effect is generated directly using a program that causes the CPU to activate the flame light LEDs in a sequence that creates the appearance of a moving flame on the projection screen. Use of a multiple flame light LED system allows this to work because, unlike conventional incandescent lighting, each of the individual LEDs can be controlled with the exacting precision in a pre-determined sequence that results in an image of a realistic moving flame on the projection screen.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. An electric fireplace insert comprising:
a projection screen onto which light can be projected to simulate the appearance of flames;
a flame light system comprising a plurality of flame light-emitting diodes arranged to produce light that is projected onto the projection screen in the form of simulated flames;
a simulated fuel source having an outer surface comprising at least one translucent or transparent portion, and at least one interior cavity defined at least in part by the at least one translucent or transparent portion;
a simulated fuel source lighting system comprising a plurality of simulated fuel source light-emitting diodes arranged to project light into the at least one interior cavity of the simulated fuel source and onto the at least one translucent portion of the simulated fuel source;
a simulated ember bed having an outer surface comprising at least one translucent or transparent portion, and at least one interior cavity defined at least in part by the at least one translucent or translucent portion;
a simulated ember bed lighting system comprising a plurality of ember bed light-emitting diodes arranged to project light into the at least one interior cavity of the simulated ember bed and onto the at least one translucent portion of the simulated ember bed; and
a controller comprising at least one central processing unit, and controlling the operation of flame light system, the simulated fuel source lighting system, and the simulated ember bed lighting system.

2. The electric fireplace insert of claim 1, wherein the plurality of flame light-emitting diodes comprises at least a first flame light-emitting diode and a second flame light-emitting diode, the first flame light-emitting diode being controlled by the controller independently from the second flame light-emitting diode.

3. The electric fireplace insert of claim 1, wherein the plurality of fuel source light-emitting diodes comprises at least a first fuel source light-emitting diode and a second fuel source light-emitting diode, the first fuel source light-emitting diode being controlled by the controller independently from the second fuel source light-emitting diode.

4. The electric fireplace insert of claim 1, wherein the plurality of ember bed light-emitting diodes comprises at least a first ember bed light-emitting diode and a second ember bed light-emitting diode, the first ember bed light-emitting diode being controlled by the controller independently from the second ember bed light-emitting diode.

5. The electric fireplace insert of claim 2, wherein the plurality of fuel source light-emitting diodes comprises at least a first fuel source light-emitting diode and a second fuel source light-emitting diode, the first fuel source light-emitting diode being controlled by the controller independently from the second fuel source light-emitting diode.

6. The electric fireplace insert of claim 2, wherein the plurality of ember bed light-emitting diodes comprises at least a first ember bed light-emitting diode and a second ember bed light-emitting diode, the first ember bed light-emitting diode being controlled by the controller independently from the second ember bed light-emitting diode.

7. The electric fireplace insert of claim 2, wherein the plurality of fuel source light-emitting diodes comprises at least a first fuel source light-emitting diode and a second fuel source light-emitting diode, the first fuel source light-emitting diode being controlled by the controller independently from the second fuel source light-emitting diode, and the plurality of ember bed light-emitting diodes comprises at least a first ember bed light-emitting diode and a second ember bed light-emitting diode, the first ember bed light-emitting diode being controlled by the controller independently from the second ember bed light-emitting diode.

8. The electric fireplace insert of claim 1, further comprising a right interior facade positioned on a right interior side wall of the insert, a left interior facade positioned on a left interior side wall of the insert, and a down lighting system comprising a plurality of down light light-emitting diodes arranged to project light onto the simulated fuel source, the right interior facade, and the left interior facade.

9. The electric fireplace insert of claim 8, wherein the plurality of down light light-emitting diodes comprises at least a first down light light-emitting diode, a second down light light-emitting diode, and a third down light light-emitting diode, wherein the first down light light-emitting diode light-emitting diode is controlled by the controller independently from the second down light light-emitting diode and the third down light light-emitting diode.

10. The electric fireplace insert of claim 1, wherein the flame light system further comprises a flame cutout panel through which light from the plurality of flame light-emitting diodes can be formed into the shape of simulated flames.

11. The electric fireplace insert of claim 1, wherein the simulated fuel source has the appearance of a log set.

12. The electric fireplace insert of claim 1, wherein the controller controls the brightness level of at least one light-emitting diode selected from the group consisting of one of the simulated fuel source light-emitting diodes and one of the ember bed light-emitting diodes.

13. The electric fireplace of claim 12, wherein the brightness level of the at least one light-emitting diode is selected from one of a set of discrete brightness levels, and controller is programmed to signal the at least one light-emitting diode to change only from a first brightness level to a second brightness level, wherein the second brightness level is the one in the set of discrete brightness levels that is either the next brightest or next less brightness level.

14. The electric fireplace of claim 12, wherein the brightness level of the at least one light-emitting diode is changed every 40-160 milliseconds.

15. The electric fireplace insert of claim 1, further comprising a memory storage device having stored therein a file encoding a soundtrack, and an audio speaker in communication with the storage device.

16. The electric fireplace insert of claim 15, wherein the soundtrack comprises a pattern of sounds that simulates the sound of burning wood.

17. The electric fireplace insert of claim 15, wherein the pattern of sounds does not repeat for at least 30 seconds.

18. The electric fireplace insert of claim 15, wherein the controller synchronizes the pattern of sounds with the flashing of at least one of the light-emitting diodes comprising the flame light system, the simulated fuel source lighting system, or the simulated ember bed lighting system.

19. The electric fireplace insert of claim 1, wherein the insert is comprised within a fireplace housing comprising a front portion to which a decorative face plate is reversibly attached.

20. A method comprising the steps of simultaneously:
using a first set of light-emitting diodes to project simulated flames onto a projection screen positioned in an electric fireplace insert; and
using a second set of light-emitting diodes to project light into an interior cavity of a simulated fuel source positioned in the electric fireplace insert and having an outer surface comprising at least one translucent or transparent portion that defines at least in part the at least one translucent or transparent portion.

21. The method of claim 20, further comprising the step of:
using a third set of light-emitting diodes to project light into an interior cavity of a simulated ember bed positioned in the electric fireplace insert and having an outer surface comprising at least one translucent or transparent portion that defines at least in part the at least one translucent or transparent portion.

22. The method of claim 20, further comprising the step of:
using a third set of light-emitting diodes to project light downward onto the simulated fuel source, a right interior facade of the fireplace insert, and a left interior facade of the fireplace insert.

23. The method of claim 20, further comprising the step of:
playing a soundtrack through an audio speaker position on the fireplace insert, wherein the soundtrack comprises a pattern of sounds that simulates the sound of burning wood.

24. The method of claim 23, wherein the pattern of sounds does not repeat for at least 30 seconds.

25. The method of claim 23, wherein the pattern of sounds is synchronized with the flashing of at least one of the light-emitting diodes.
